(19) United States
(12) Patent Application Publication
(10) Pub. No.: US 2012/0170713 A1
(43) Pub. Date: Jul. 5, 2012

(54) SYSTEM FOR INSPECTING OBJECTS BY MEANS OF ELECTROMAGNETIC RAYS, PARTICULAR BY MEANS OF X-RAYS

(76) Inventors: Erwin KIRSTEN, Ingelheim (DE); Rudolf Kremer, Erbach (DE); Fred Hemp, Bingen (DE); Stefan Aust, Idstein (DE)

(21) Appl. No.: 13/251,894

(22) Filed: Oct. 3, 2011

Related U.S. Application Data
(63) Continuation of application No. PCT/EP2010/001828, filed on Mar. 24, 2010.

(30) Foreign Application Priority Data
Apr. 1, 2009 (DE) 10 2009 015 247.4

(51) Int. Cl. G01N 23/02

(52) U.S. Cl. 378/57

(57) ABSTRACT

A system for testing objects by means of electromagnetic rays is provided that includes at least one test unit which contains at least one radiation source, arranged in a transportable, container-like housing, for producing electromagnetic radiation and at least one detector array associated with the radiation source. The test system contains at least two test units arranged beside one another, each having at least one radiation source, which are arranged in such a way that the object is irradiated from different directions.

This nonprovisional application is a continuation of International Application No. PCT/EP2010/001828, which was filed on Mar. 24, 2010, and which claims priority to German Patent Application No. DE 10 2009 015 247.4, which was filed in Germany on Apr. 1, 2009, and which are both herein incorporated by reference.

### BACKGROUND OF THE INVENTION

1. Field of the Invention

The invention relates to a system for inspecting objects by means of electromagnetic rays, particularly by means of x-rays, having at least one inspection unit, which has at least one radiation source, arranged in a transportable, container-like housing, for generating magnetic radiation and at least one detector array assigned to the radiation source.

2. Description of the Background Art

The screening of large-volume objects starting with the size of an assembled euro pallet (W×L×H: 0.8 m×1.2 m×1.8 m) is becoming increasingly important within the context of customs clearing and security-related inspection. This applies in particular to airfreight in cargo aircraft or as additional cargo in passenger aircraft, but also to small vehicles.

X-ray inspection systems for large-volume objects are known to be self-propelled devices, which are moved over the object, or as stationary x-ray systems, by which the large-volume inspection object (inspection product) is passed.

DE 195 32 965 C2, which corresponds to U.S. Pat. No. 5,692,028, discloses a mobile x-ray inspection system for large-volume products, such as, for example containers, trucks, and passenger cars, whereby the inspection system as a self-propelled apparatus is moved over the inspection object.

EP 0 412 190 B1, which corresponds to U.S. Pat. No. 5,065,418, discloses a stationary irradiation system for irradiating containers and/or vehicles, which is used, for example, at airports to examine the contents for explosives, weapons, illegal drugs, and contraband.

DE 11 2007 000 011 T5, which corresponds to U.S. Pat. No. 7,817,775, also describes a stationary inspection system for inspecting pallet loads, air freight containers, and other large-volume loads by means of radiation, whereby the inspection objects are taken via a conveying device to a radiation scanning unit, which straddles the conveying device.

### SUMMARY OF THE INVENTION

The object of the invention is to provide a system for inspecting objects of the generic type, which enables with a high inspection quality a simplified adaptation to different intended uses.

Said object is attained in an embodiment in that the system has at least two inspection units, arranged next to one another, having at least one radiation source, arranged in a transportable, container-like housing, the radiation sources being arranged so that the object is irradiated from different directions.

In an embodiment, the inspection system contains at least two radiation sources, which are arranged in at least one transportable, container-like housing and emit energy in a range of 150 KeV to 500 KeV, particularly of about 300 KeV, and in a range between 1 MeV to 7 MeV, preferably 3 MeV to 5 MeV, particularly of about 3.5 MeV.

The evaluation of rays in a range of 150 KeV to 500 KeV and in a range between 1 MeV to 7 MeV offers high detail recognition in the lower energy range and at the same time high penetration power in the higher energy range.

Preferably, the x-rays are emitted from at least one radiation source fan-shaped in a radiation plane. An improved resolution is achieved, when at least two radiation sources are used with radiation planes parallel to one another.

Preferably, the inspection units are designed so that they can also be operated interference-free outside of buildings. The systems are thus suitable for utilization in interior areas, in areas with covers, and for outdoor applications. In the outdoor area, the system permits two-dimensional irradiation of dollies and small vehicles.

Advantageously, the inspection units can also be designed so that they can be integrated into an existing conveying system. They can be integrated, for example, into existing cargo loading systems at airports or terminals.

A module-like design of the inspection units in such a way that two or more units can be assembled into a complete system offers the great advantage that the system can be adapted cost-effectively to different applications. If necessary, the system can be expanded very cost-effectively with use of already present inspection units.

Possible fields of application of an inspection system of the invention are, for example, border crossings points, seaports and airports, customs facilities, tollbooths, cargo centers, general security zones, and industrial and military installations.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1A shows a perspective front view of an inspection system according to the present invention, which is made up of two inspection units, and

FIG. 1B shows a perspective back view of the inspection system shown in FIG. 1A.

### DETAILED DESCRIPTION

Inspection system 1 comprises substantially two inspection units 2, 3 and a conveying device 5, a roller conveyor in the example, on which a large-volume inspection object 4 for irradiation is conveyed through the area between the radiation sources and the detector arrays 2.3, 3.3 of inspection units 2, 3.

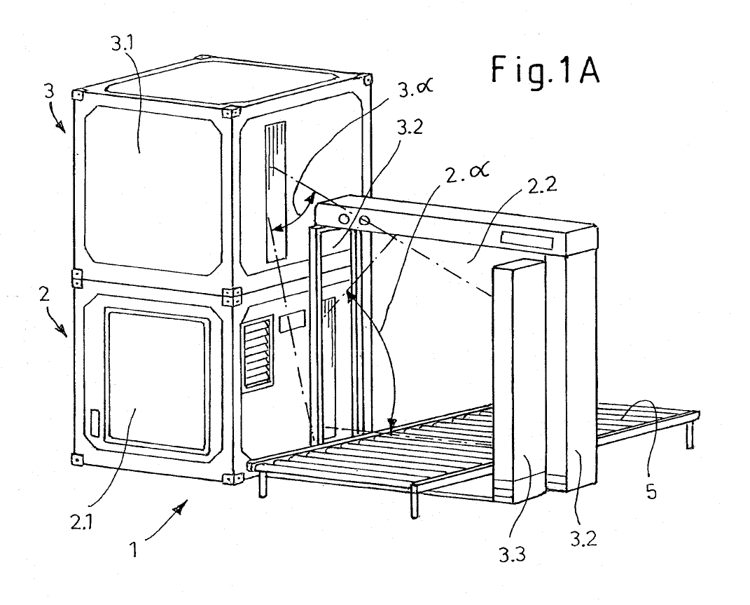

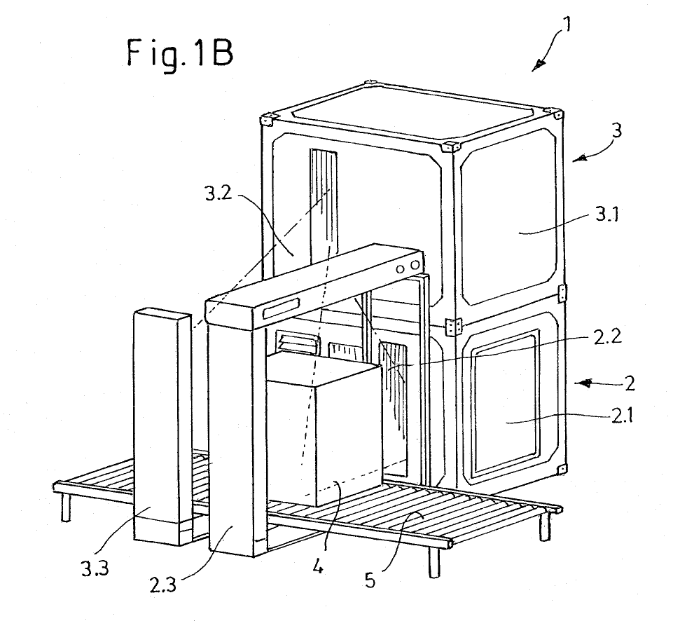

Each inspection unit 2, 3 has a transportable, container-like housing 2.1, 3.1, in which in each case at least one x-ray source is arranged. Each radiation source generates x-radiation, which is emitted fan-shaped in a radiation plane and emerges from the respective housing 2.1, 3.1. Preferably, at least two radiation sources are present whose radiation planes are parallel to one another, as shown in FIG. 1A and FIG. 1B. In the present exemplary embodiment, the radiation planes of fan beams 2.2, 3.2 are oriented perpendicular to the transport direction of conveying device 5, so that an inspection object 4 is passed through the fan beams by means of conveying device 5 perpendicular to the radiation plane of fan beams 2.2, 3.2.

There are two vertical or horizontal inspection units 2, 3 arranged next to one another, each of which contains a radiation source, and said sources are arranged so that the inspection object is irradiated from different directions.

In so doing, the fan beams run in parallel planes, but they emit radiation onto inspection object 4 from different directions: In the first inspection unit 3, arranged on top, the fan beam opens from top left to bottom right and in the case of the second inspection unit 2, the fan beam opens from bottom right to top left.

Each fan beam 2.2, 3.2 is assigned a detector array 2.3, 3.3. Detector arrays 2.3, 3.3 have an L-shaped form, whereby the plane spanned by the legs of the particular detector array 2.3, 3.3 lies within the radiation plane of the associated fan beam 2.2, 3.2. The transverse leg of second detector array 2.3 runs above conveying device 5 and straddles it at a specific vertical distance, so that detector array 2.3 together with the side walls of housing 2.1, 3.1 forms a door, through which inspection object 4 to be examined is conveyed with the aid of conveying device 5.

If the inspection system is used outdoors, irradiation of small vehicles, for example, delivery trucks (vans) and dollies, is also possible. In this intended use, the receiver modules of the detector arrays are preferably arranged in part in the conveying system for the small vehicles and/or in a covered sub-surface inspection lane.

Advantageously, in inspection system 1 x-ray emitters are used as radiation sources, which emit x-radiation with an energy in a range of 150 KeV to 500 KeV, particularly of about 300 KeV, and in a range between 1 MeV to 7 MeV, preferably 3 MeV to 5 MeV, particularly of about 3 MeV. Cost-effective x-ray emitters with an energy of about 300 KeV and about 3.5 MeV are used in the present exemplary embodiment. To generate x-radiation in the higher range of about 3.5 MeV, it is preferable to use a circular accelerator, and for generating the lower energy range of about 300 KeV, known x-ray tubes. The intensities of the radiation penetrating inspection object 4 are measured by the assigned detector arrays 2.3, 3.3 and evaluated separately for both energy ranges. The evaluation of both ranges enables both high detail detection, for example, the detection of wires and other fine structures within inspection object 4; in other respects, x-radiation in the higher energy range has a high penetration power, so that thick and/or especially dense inspection objects 4 can be inspected.

As shown in the figures, each inspection unit 2, 3 is designed in modular manner so that two or more units can be assembled into a complete system. This enables, firstly, as described above, the combination of two inspection units 2, 3, which operate at different energies, for example, the combination of a 300-KeV irradiation unit with a 3.5-MeV irradiation unit.

Likewise, irradiation with x-rays in two directions is possible, as shown in the figures. Irradiation in both directions can thereby occur both with the same energy range and with different energy ranges. Inspection units 2, 3 are designed so that they can be integrated into an existing conveying system particularly the conveying system of a cargo loading system.

Inspection system 1 contains further an evaluation unit that receives the electrical signals from detector arrays 2.3, 3.3 and processes said signals further for an analysis for sought items or substances. The result can be displayed in the form of a visual presentation on an appropriate display unit and checked by an operator. In so doing, it is possible that each inspection unit 2, 3 contains its own evaluation unit, or the entire inspection system 1 contains only a single evaluation unit, in which the data determined by the individual inspection units 2, 3 are evaluated. In the last case, the inspection units have appropriate interfaces, which enable a data connection with the evaluation unit in a different housing.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A system for inspecting objects via electromagnetic rays, the system comprising:
at least one inspection unit comprising:
at least one radiation source arranged in a transportable container-like housing for generating electromagnetic radiation; and
at least one detector array assigned to the radiation source,
wherein the inspection system has at least two inspection units arranged next to one another, each inspection unit having at least one radiation source arranged so that the object is irradiated from different directions.

2. A system for inspecting objects via electromagnetic rays, the system comprising:
at least one inspection unit comprising:
at least one radiation source arranged in a transportable container-like housing for generating electromagnetic radiation; and
at least one detector array assigned to the radiation source,
wherein the x-ray system contains at least two radiation sources, which emit x-radiation with an energy in a range of 150 KeV to 500 KeV, or about 300 KeV, and in a range between 1 MeV to 7 MeV, or 3 MeV to 5 MeV, or about 3.5 MeV.

3. The system for inspecting objects according to claim 1, wherein the radiation sources emit x-radiation with an energy in a range of 150 KeV to 500 KeV, or about 300 KeV, and in a range between 1 MeV to 7 MeV, or 3 MeV to 5 MeV, or about 3.5 MeV.

4. The system according to claim 1, wherein the x-radiation is emitted fan-shaped in a radiation plane from at least one radiation source.

5. The system according to claim 4, further comprising at least two radiation sources, whose radiation planes are parallel to one another.

6. The system according to claim 1, wherein the detector array of an inspection unit is L-shaped.

7. The system according to claim 1, further comprising a conveying device via which objects for inspection are conveyed through the inspection units.

8. The system according to claim 1, wherein the inspection unit is designed so that it operateable interference-free outside of buildings.

9. The system according to claim 1, wherein the inspection unit is designed so that it is integrateable into an existing conveying system and/or a cargo loading system.

10. The system according to claim 1, wherein each inspection unit is designed in a modular manner so that two or more units can be assembled into a complete system.
